(19) United States
(12) Patent Application Publication
(10) Pub. No.: US 2024/0391082 A1
(43) Pub. Date: Nov. 28, 2024

(54) HOUSING FOR AN ELECTRIC HAND-HELD POWER TOOL

(71) Applicant: C. & E. Fein GmbH, Schwaebisch Gmuend-Bargau (DE)

(72) Inventors: Juergen BLICKLE, Goeppingen (DE); Horst FAHRNER, Stuttgart (DE)

(73) Assignee: C. & E. Fein GmbH, Schwaebisch Gmuend-Bargau (DE)

(21) Appl. No.: 18/792,002

(22) Filed: Aug. 1, 2024

Related U.S. Application Data
(63) Continuation of application No. PCT/EP2023/052390, filed on Feb. 1, 2023.

(30) Foreign Application Priority Data
Feb. 2, 2022 (EP) 22154771.4

(51) Int. Cl. B25F 5/02; B24B 23/02

(52) U.S. Cl. CPC B25F 5/02; B24B 23/028

(57) ABSTRACT

A housing for an electric hand-held power tool, in particular for an angle grinder, having a housing opening for a mains cable end and having a maintenance opening which can be closed by a maintenance cover in order to permit manual access to the line contacts of the mains cable end which are arranged under the maintenance cover. An electric hand-held power tool formed with the housing is also provided.

This nonprovisional application is a continuation of International Application No. PCT/EP2023/052390, which was filed on Feb. 1, 2023, and which claims priority to European Patent Application No. 22154771.4, which was filed on Feb. 2, 2022, and which are both herein incorporated by reference.

### BACKGROUND OF THE INVENTION

### Field of the Invention

The invention relates to a housing for an electric hand-held power tool, and to an electric hand-held power tool, in particular an angle grinder, that includes this housing.

### Description of the Background Art

Electric hand-held power tools generally have a housing that can be opened for maintenance purposes. Such maintenance is necessary, for example, when parts subject to wear must be checked or replaced. It has been shown from statistical observations that, for example, the power cable and its end section that extend through a housing opening and into the housing interior, where the lines of the power cable are connected to line contacts, represent one possible part that is subject to wear in electric hand-held power tools. Since power cables are frequently moved by the operator, the cable ends show residual susceptibility to cable breakage, contact interruptions, or other damage, despite the bend protection sleeves that are often used.

On the other hand, opening a housing for maintenance purposes represents a risk for the consistency of operational readiness of the electric hand-held power tool, since upon opening, contaminants may inadvertently reach sensitive components, or components may be accidentally manipulated and/or damaged by the user. The invention is based on the observation that the great majority of components situated in the housing seldom fail during the service life of the electric hand-held power tool.

### SUMMARY OF THE INVENTION

It is therefore an object of the present invention to provide a housing for an electric hand-held power tool and the electric hand-held power tool that includes same, in which maintenance of parts subject to wear may take place efficiently and with reduced risk for the operational capability of the further components of the electric hand-held power tool.

The maintenance cover of the housing offers the advantage that a majority of the housing interior may remain closed when maintenance of the power cable end occurs. Only the limited region of the interior subsection situated below the maintenance cover is exposed, which allows maintenance of the power cable end, the electrical lines exiting therefrom, their contacting with the line contacts, and the condition of the line contacts. The housing, in particular the maintenance cover, can be configured in such a way that the lines of the power cable are detachable from the line contacts, in particular in a closed position of the housing. The housing, in particular the maintenance cover, can be configured in such a way that the power cable end is removable form the housing, in particular in the open position of the maintenance cover.

An interior subsection can be understood in particular to mean the section of the housing interior, enclosed by the housing, in which, in the state for which the power cable is mounted at the closed housing or an electric hand-held power tool, the power cable end extends within the housing interior, and in which in particular the ends of the lines of the power cable end and in particular the line contacts for connecting the lines of the power cable are situated. In general, the interior subsection is the section of the housing interior in which the component that is to be serviced through a maintenance opening is situated. The interior subsection can encompass essentially the section of the housing interior that is situated below the maintenance cover. In particular, this section extends perpendicularly with respect to an inner wall of the maintenance cover in the direction of the housing interior.

The housing can have at least one first housing portion and one second housing portion, which in a closed position of the housing are joined together, and are separated from one another in an open position of the housing, the housing in particular being configured in such a way that in the closed position of the housing the maintenance cover is transferable from its closed position into its open position.

The housing can extend along an imaginary longitudinal axis A of the housing, wherein a drive shaft of the drive of the electric hand-held power tool is situatable in the housing interior, in particular in parallel to this longitudinal axis. The first housing portion is preferably a first housing shell, in particular a housing half, that encloses a first housing interior section that is opened in parallel to a plane E. The second housing portion is a second housing shell, in particular a housing half, that encloses a second housing interior section that is opened in parallel to the same plane E. The first and second housing shells are connected along this plane E in the closed position of the housing in order to jointly delimit a housing interior that is formed from the first and second housing interior sections. The longitudinal axis A extends in parallel to the plane E, and in particular is situated in this plane E.

The housing can extend along an imaginary longitudinal axis A, wherein a drive shaft of the drive of the electric hand-held power tool is situatable in the housing interior, in parallel to this longitudinal axis. The housing preferably has a first, in particular closed, housing end in which the housing opening for the power cable is situated, and in particular has a second housing end, preferably connectable to an output housing, through which the drive shaft is guidable. The maintenance cover, in relation to the length of the housing measured at the longitudinal axis A, is preferably closer to one housing end, in particular closer to the first housing end, than to the center of the housing. In this way, only an edge region of the housing interior is exposed to the surroundings during the maintenance.

The first housing end can be formed by an end-face wall whose outer surface extends, at least in part, perpendicularly with respect to the longitudinal axis A. The housing opening is preferably situated in the region of the first housing end. The end-face wall in the closed position of the housing is preferably formed partly by the first housing portion and the second housing portion, and in the closed position of the housing is preferably formed partly by the maintenance cover. This results in particular in easy access to the power cable end for maintenance purposes.

The maintenance cover can encompass at least a portion, in particular one-half, of the housing opening for the power cable end. The power cable is thus preferably easily removable when the maintenance cover of the housing opening is open. The housing opening for the power cable and the maintenance opening preferably merge into one another when the maintenance opening is open. The housing opening for the power cable is preferably configured in such a way that a power cable end, situated in the housing opening in the closed position of the maintenance cover, is removable from the housing opening in the open position of the maintenance cover.

The maintenance cover in its closed position can have an edge section and/or a corner section of the housing, each of which may in particular have a rounded shape. The edge section or corner section allows convenient maintenance access to the interior subsection.

The maintenance cover can be designed to rest in a form-fit manner against a housing edge that forms the maintenance opening. When the maintenance opening is closed, this prevents contaminants from entering the housing interior from the outside. This results in protection of the housing interior from dirt. The closure of the maintenance opening is thereby improved.

The maintenance cover can form a wall section of the housing having an outer side, the wall section of the maintenance cover in the closed position of the maintenance cover in particular being at least partially aligned with the outer side of the housing. The wall section preferably has an inner side at which in particular at least one protrusion is formed, which establishes a form-fit connection with a recess in the housing when the maintenance cover is in its closed position. The recess for establishing the form-fit connection may be provided at a protrusion of the housing in its interior, and/or at a structure that is situatable in the housing interior.

The maintenance cover can have a design that is completely separable from the housing.

The housing can have a connection device via which the maintenance cover is connectable to the housing. The connection device comprises in particular at least one through hole for accommodating a screw, in particular at least one thread, formed in the housing, for receiving the screw, and in particular the at least one screw. The maintenance cover preferably has at least one through hole, in particular at least two or exactly two through holes, through which a screw, via which the maintenance cover is fastenable to the housing, is guidable in each case.

The maintenance cover in its open position can be connected to the housing, in particular via a connection assembly, which in particular may involve a hinge or a movable connecting element, in particular a cable, a band, or a film.

The maintenance cover and/or the housing and/or a housing portion can be essentially formed in each case from at least one injection-molded part or include(s) an injection-molded part.

The outer surface of the maintenance cover may occupy less than a proportion f of the outer surface of the housing, where f is selected from the group of preferred values (0.25; 0.2; 0.15; 0.1; 0.05; 0.04; 0.03; 0.02; 0.01). The opening cross section of the maintenance opening, which in particular may essentially correspond to the outer and/or inner surface of the maintenance cover, or the outer surface or the inner surface of the maintenance cover is preferably less than a, where a is selected from the group of preferred values (64 cm², 49 cm², 36 cm², 25 cm², 16 cm², 9 cm², 4 cm²).

The invention further relates to a housing for an electric hand-held power tool, in particular an angle grinder, that encloses a housing interior in which a drive electronics system for controlling a drive, situatable in the housing interior, for driving a tool receptacle of the electric hand-held power tool may be situated. At least one component, to be serviced, of the electric hand-held power tool is or may be situated in an interior subsection of the housing interior. The housing has a maintenance opening adjoining the interior subsection, and a maintenance cover which in a closed position closes the maintenance opening and releases it in an open position. This allows access to the at least one component, to be serviced, in the interior subsection, in particular in order to replace it. The at least one component to be serviced, as claimed herein, may be a power cable end, and/or in particular the lines thereof that extend into the housing interior, and/or in particular may be the line contacts.

The invention also relates to an electric hand-held power tool, in particular an angle grinder, in particular an electronically commutated grid-powered angle grinder, having a housing according to the invention, and a drive electronics system, situated in the housing interior, for controlling a drive, situated in the housing interior, for driving a tool receptacle. The tool receptacle is preferably situated at a tool shaft that is coupled to the drive, a tool being detachably mounted on the tool receptacle. The electric hand-held power tool includes a power cable that is used to supply power to the drive electronics system, and whose power cable end preferably extends through the housing opening into the interior subsection of the housing interior, and/or whose lines are preferably connected to line contacts situated in the interior subsection. The drive is in particular a brushless drive that includes a brushless motor.

The invention further relates to a method for manufacturing the housing according to the invention, in particular according to one or more of the described optional, advantageous examples, comprising the steps: injection molding of the housing having the housing opening and the maintenance opening, in particular injection molding of a first housing portion and injection molding of a second housing portion; and injection molding of the maintenance cover.

The invention further relates to a method for manufacturing the electric hand-held power tool according to the invention, in particular the angle grinder, which includes the housing according to the invention, comprising the steps: providing the housing according to the invention; and connecting the maintenance cover to the housing in order to close the maintenance opening.

Further examples of the housing according to the invention for an electric hand-held power tool, and the electric hand-held power tool, in particular the angle grinder, which includes this housing, result from the following description of the examples according to the figures.

The invention relating to the housing for an electric hand-held power tool is explained below, in part with reference to the completely installed electric hand-held power tool, since various structural features of the housing may be derived from the arrangement of the components of the electric hand-held power tool relative to the housing. The statements below with regard to the electric hand-held power tool are therefore also to be construed such that the housing associated with this electric hand-held power tool is configured to form the electric hand-held power tool. Features of the housing according to the invention may thus be derived from the figures, even if reference is being made to the electric hand-held power tool.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the perspective view of an electric hand-held power tool, which is equipped with the housing according to the invention according to an example of the invention.

FIG. 2 shows a top view of the electric hand-held power tool in FIG. 1.

FIG. 3 shows a top view of an exploded illustration of the electric hand-held power tool in FIG. 1, in which two halves of the housing according to the invention and also the maintenance cover are detached from the electric hand-held power tool.

FIGS. 4a through 4d each show a detailed perspective view of the first housing end of the electric hand-held power tool in FIG. 1, in an open position of the maintenance cover.

FIG. 5a shows a side view of the first housing end, in the present case the first housing half, of the electric hand-held power tool in FIG. 1.

FIG. 5b shows a side view of the first housing end, in the present case the second housing half, of the electric hand-held power tool in FIG. 1.

FIGS. 6a and 6b each show a perspective view of the maintenance cover, in particular the inner side thereof, of the electric hand-held power tool in FIG. 1.

### DETAILED DESCRIPTION

The figures each show examples of an electric hand-held power tool 1, in the present case an angle grinder 1, that is equipped with a housing 20 according to the invention according to an example.

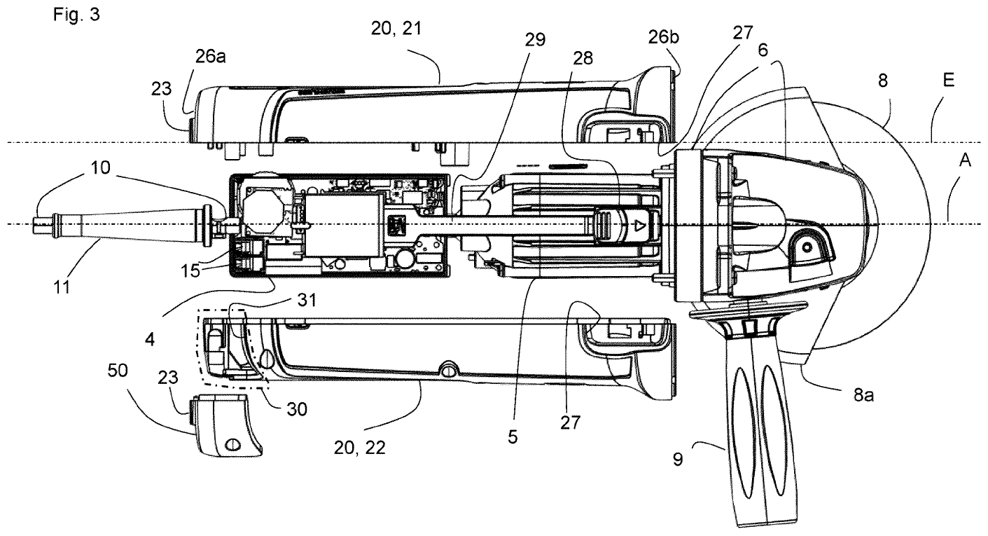

FIG. 3 shows the housing open position in which the first housing half 21 and the second housing half 22 are separated from one another by releasing the connector for connecting the housing halves, in the present case screws. This allows a view of the components in the housing interior.

Situated in the housing interior is an electric drive 5, designed here as a brushless electronically commutated grid-powered electric motor 5, whose drive shaft is concentrically situated with respect to the longitudinal axis A for rotation about same. The drive shaft extends into the output housing 6, which closes the open second housing end 26b and contains a gear head. The tool shaft, which is used as an output and is coupled to the drive shaft via a gear, is situated perpendicularly with respect to the longitudinal axis A and is supported so that it is rotatable about this vertical direction. The tool 8, in the present case a grinding wheel 8 that is partially covered by a protective hood 8a, is detachably mounted on the tool shaft or tool receptacle.

A handle 9 is mounted on the output housing 6; the housing 20 itself is likewise used for manipulating the electric hand-held power tool, and may be utilized as an additional handle.

The drive electronics system 4 in the form of a circuit board 4 is situated in the housing interior, neighboring the closed first housing end 26a of the housing 20, and in particular is fastened to the inner side of the housing. Electronic components are situated on the circuit board 4, and in particular portions of the power supply electronics system are situated on the side of the circuit board facing the first housing end 26a, in addition to IGBT components as integral parts of the drive circuit, motor switches for supplying the brushless electronically commutated grid-powered electric drive with power, a rectifier, a capacitor, microcontrollers, drivers, sensors, LEDs, and the power path of the output stage and the motor.

The electronic components of this drive electronics system 4 are all ultimately supplied with voltage via the power cable 10, and this voltage is transformed to the output voltages required by the components of the drive electronics system. The power cable 10 or its end 10 visible here is two-poled, and contains two lines which exit from the power cable sheath that opens into the housing interior, and which are led through an interior subsection of the housing interior situated at the first housing end 26, in order to open into the line contacts 15 in which the copper cores of the lines are contacted by clamping the line contacts 15.

The housing 20 has an opening 27, which in the closed position of the housing here is formed by two cavities, one in the first housing half 21 and one in the second housing half 22, and into which an actuating element 28, which is used as a start/stop switch for operating the angle grinder and is movable toward the output housing in the direction of the axis A, enters. Via the switch rod 29 that extends in the housing interior in the axial direction A, the actuating movement is transferred to a switch mounted on the circuit board.

The power cable, more precisely the power cable end 10 thereof, used for supplying power to the drive electronics system penetrates through the housing opening 23 into the interior subsection of the housing interior in which the line contacts 15 are situated. The power cable end 10 is enclosed by an elastic sleeve 11 which serves as anti-kink protection, and which together with the power cable end 10 enters through the housing opening 23 and into the interior subsection. Two lines exit from the end section of the power cable 10, and their copper cores are connected to the clamping contacts of the two line contacts 15 by clamping. As explained above, in the present example in the closed position of the housing, the housing opening 23 (which has a circular cross section here) is formed by a first semicircular cavity in the first housing half 21 and a second semicircular cavity in the maintenance cover 50.

The geometric shapes of the first housing half 21 and second housing half 22 here are essentially such that mirror symmetry of the two housing halves 21, 22 results, in relation to the plane E that extends through the longitudinal axis A and in parallel to the opening 21a in the first housing half 21 and the opening 22a in the second housing half 22. However, the second housing half 22 differs from the first housing half 21 in that the second housing half 22, in the open position of the maintenance cover 50, has a maintenance opening 31, or that, in the closed position of the maintenance cover 50, a maintenance cover 50 that is separable from the remainder of the housing half 22 and that closes the maintenance opening is situated at the second housing half 22. The maintenance cover 50 encompasses a portion, in the present case essentially one-half, of the housing opening 23 for the power cable end 10.

The interior subsection 30 is a section of the housing interior that is marked with a dash-dotted boundary 30 in FIG. 3. The interior subsection 30 may in particular be defined as the section of the housing interior in which (with the angle grinder 1 mounted) the power cable end 10, in particular also an anti-kink protector 11, extend within the housing interior, and in which the line contacts 15 for connecting the lines of the power cable are situated. In this example, the interior subsection 30 is situated essentially within the subsection of the housing interior that is enclosed by the second housing half 22. The interior subsection 30, starting from the housing half 22 in which it is situated, may extend slightly into the first housing half 21. In FIG. 3, the first subsection of the housing interior extends in the first housing half 21 up to the plane E, which is adjoined by the second subsection of the housing interior in the second housing half 22 in the closed position of the housing.

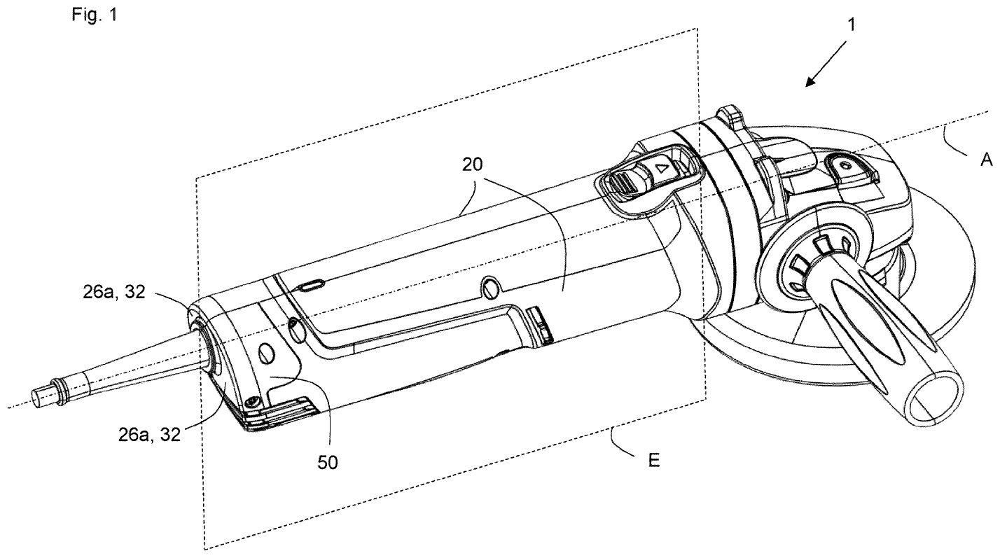

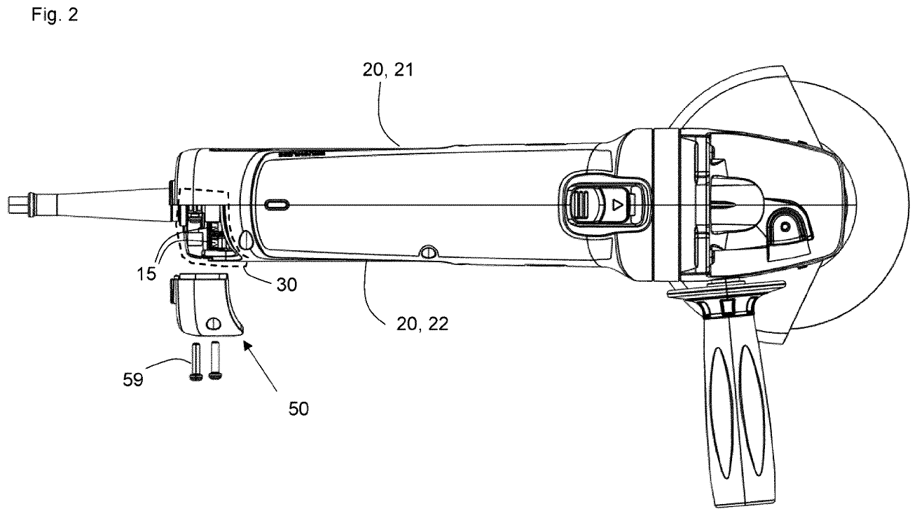

The housing 20, here in particular the second housing half 22, has the maintenance opening 31 which adjoins the interior subsection 30, and in particular has a maintenance cover 50, which in a closed position as shown in FIG. 1 closes the maintenance opening 31 and releases it in an open position, as shown in FIG. 2, to allow manual access to the line contacts 15 that are situatable in the interior subsection. The maintenance cover 50 here is completely separable from the housing, and is fastened by screws. The fastener, for example, screws may be situated at the first housing half 21 and also at the second housing half 22.

A first housing end 26a of the housing 20 is formed by an end-face wall 32 whose outer surface extends, at least in part, perpendicularly with respect to the longitudinal axis A, and in which the housing opening 23 is situated. In the closed position of the housing, the end-face wall 32 is formed in part by the first housing portion 21 and the second housing portion 22, in the closed position of the housing in particular the end-face wall 32 being formed in part by the maintenance cover 50 (see FIG. 1). In the closed position of the housing, in which the maintenance cover 50 closes the interior subsection 30, the maintenance cover 50 is part of the housing portion 22, and together with same forms the second housing half 22.

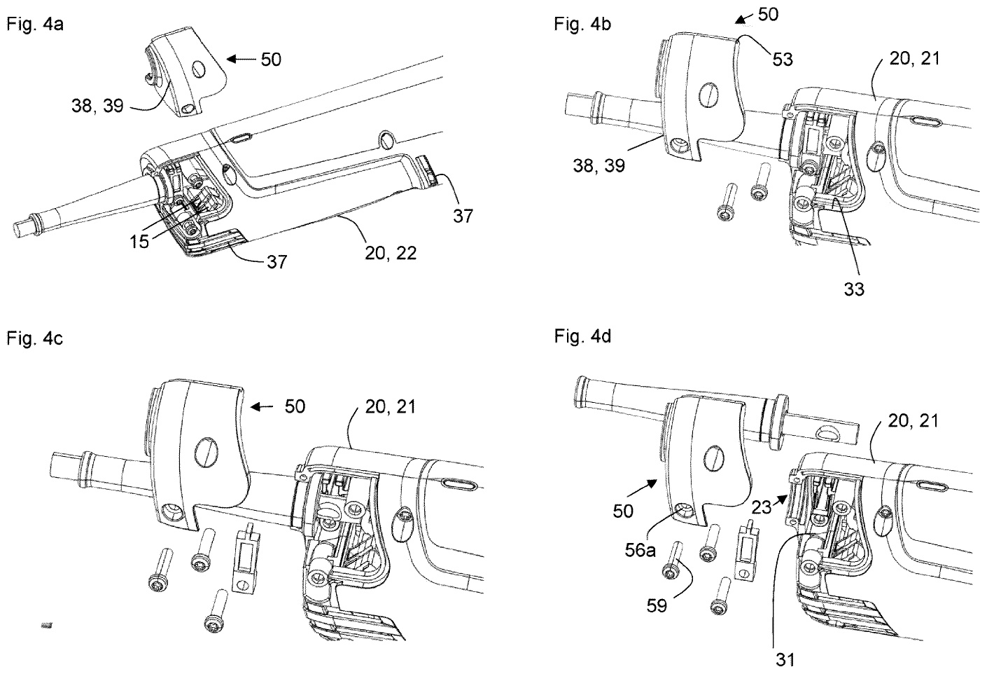

As is apparent in FIG. 4d, for example, when the maintenance opening 31 is open the housing opening 23 and the maintenance opening 31 merge into one another, i.e., are not separated by components. This transition is designed in particular in such a way that when the maintenance opening is open, the power cable is detachable from the housing openings 23, 31, and after the lines are separated from the line contacts 15, the power cable end is removable from the housing interior through the maintenance opening 31. The power cable may thus be checked and replaced, even if the housing 20 as a whole is essentially closed, and only the maintenance opening 31 is open. Maintenance is thus uncomplicated, and access or damage by other areas or components situated in the housing interior, which in particular are outside the interior subsection 30 that is accessible through the maintenance opening 31, is prevented.

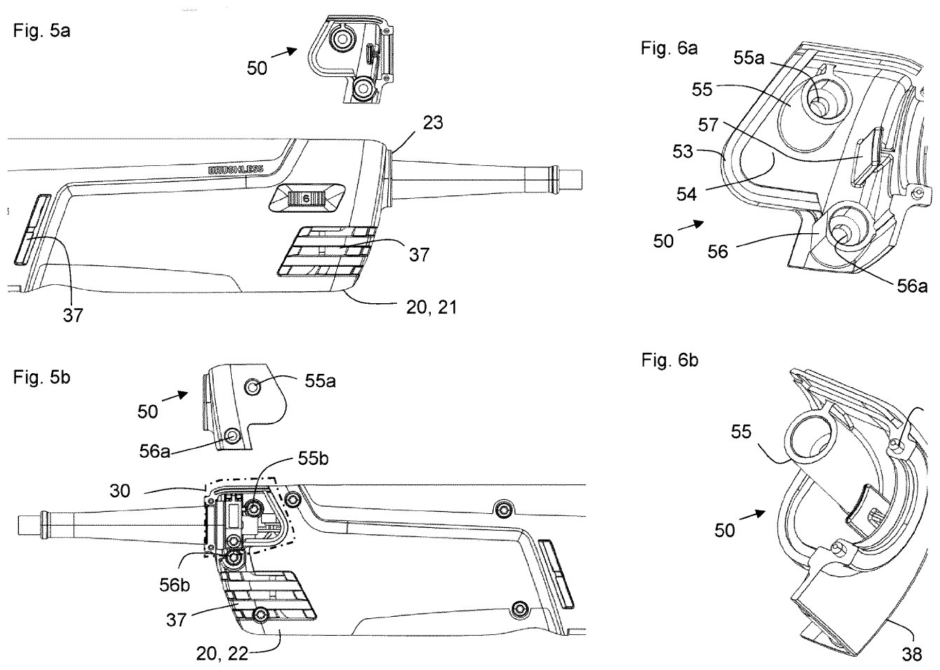

As is clearly apparent in FIGS. 4a, 4b, 6a, and 6b, the maintenance cover 50 in its closed position forms an edge section 38 and a corner section 39 of the housing 20, each of which has in particular a rounded shape. The maintenance cover 50 is designed to rest in a form-fit manner against a housing edge 33 (FIG. 4b) that forms the maintenance opening 31 of the housing 20 or of the second housing portion 22. For this purpose, the housing edge 33 has a step-shaped profile, at least in sections, that is complementary to the step-shaped profile of the cover edge 53, at least in sections (FIG. 6a), of the maintenance cover 50. The maintenance cover 50 is fastened in the closed position by means of screws 59 that engage with through holes 55a, 56a (FIG. 5b) via complementary screw bushings 55 (FIG. 4d) at the maintenance cover 50. The threads 55b, 56b for fastening the pins 59 may be situated at the first housing portion 21 and also at the second housing portion 22.

The housing 20, 21 has openings 37 for exchanging air in the housing interior with the surroundings (FIGS. 5a, 5b).

The maintenance cover 50 forms a portion of the housing 20 that has an outer side. In the closed position of the maintenance cover 50, the outer side of the maintenance cover 50 is aligned with the outer side of the housing 20.

FIG. 6a shows the inner side 54 of the wall section 50, at which a total of three protrusion sections 55, 56, 57 are formed. The protrusion sections 55, 56, 57 have a shape such that they establish a form-fit connection with preferably complementarily designed elevations in the closed position of the maintenance cover 50. The elevations may be situated at an inner side of the housing, at the first and/or second housing portion 21, 22. The form-fit connection may be designed in the form of a tongue and groove or a pin and borehole, or as a combination of both.

The housing includes a connection device via which the maintenance cover 50 is connectable to the housing 20. The connection device here encompasses two through holes 55a, 56a for accommodating a screw 59 (FIG. 6a), at least one thread 55b, 56b that is formed in the housing 20 for receiving the screw, and the at least one screw 57.

The maintenance cover 50, the first housing portion 21, and the second housing portion 22, which in particular are formed as housing halves, are each provided as an injection-molded part.

The maintenance cover 50 has a very compact design here. The outer surface of the maintenance cover occupies less than a proportion f of the outer surface of the housing, where f is 0.02, for example. The opening cross section of the maintenance opening 31 and the outer surface of the maintenance cover 50 are less than a value a, where a is approximately 9 cm² here.

The maintenance cover 50 is large enough to allow checking of the power cable end 10, the anti-kink protector 11, and the line contacts 15 in particular in the housing interior, and optionally to allow maintenance/replacement of these components 10, 11, 15. However, the maintenance cover is also as small as possible in order to keep the interior subsection small, which during maintenance is open and exposed to the surroundings. A majority of the housing interior, in particular a majority of the drive electronics system or the entire drive electronics system, except for the line contacts 15 and the overall drive 5, also remains protected by the housing 20 when the maintenance cover is open. However, in the rare case that maintenance of the drive electronics system or the drive is necessary, the housing may also be opened by first removing the maintenance cover 50 and then detaching the first housing portion 21 and second housing portion 22, which are joined together by screws, from one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A housing for an electric hand-held power tool, the housing comprising:
a housing interior enclosed by the housing;
a drive electronics system arranged in the housing for controlling an abrushless drive to drive a tool receptacle of the electric hand-held power tool;
a housing opening through which a power cable end that is used to supply power to the drive electronics system is guidable; and
an interior subsection of the housing interior in which the power cable end and line contacts of the electric hand-held power tool are arranged so that lines of the power cable end in the interior subsection are connectable to the line contacts;
a maintenance opening adjoining the interior subsection; and
a maintenance cover, which in a closed position closes the maintenance opening and releases it in an open position to allow manual access to the line contacts that are arranged in the interior subsection.

2. The housing according to claim 1, further comprising at least one first housing portion and at least one one second housing portion, which in a closed position of the housing are joined together, and are separated from one another in an open position of the housing, the housing being configured such that in the closed position of the housing, the maintenance cover is transferable from its closed position into its open position.

3. The housing according to claim 2, wherein the housing extends along a longitudinal axis, wherein a drive shaft of the drive of the electric hand-held power tool is arranged in the housing interior in parallel to the longitudinal axis, wherein the first housing portion is a first housing shell that encloses a first housing interior section that is opened in parallel to a plane, and the second housing portion is a second housing shell that encloses a second housing interior section that is opened in parallel to the same plane, wherein the first housing shell and the second housing shell are connected along this plane in the closed position of the housing in order to jointly delimit a housing interior that is formed from the first and second housing interior sections, and wherein this longitudinal axis extends substantially in parallel to the plane.

4. The housing according to claim 2, wherein the housing extends along a longitudinal axis, wherein a drive shaft of the drive of the electric hand-held power tool is arranged in the housing interior, substantially in parallel to the longitudinal axis, wherein the housing has a first closed housing end in which the housing opening for the power cable is arranged and has a second housing end connectable to an output housing through which the drive shaft is guidable.

5. The housing according to claim 4, wherein the first housing end is formed by an end-face wall whose outer surface extends, at least in part, substantially perpendicularly with respect to the longitudinal axis and in which the housing opening is situated.

6. The housing according to claim 2, wherein the end-face wall in the closed position of the housing is formed partly by the first housing portion and the second housing portion, and wherein, in the closed position of the housing the end-face wall is formed partly by the maintenance cover.

7. The housing according to claim 1, wherein the maintenance cover encompasses at least a portion of the housing opening for the power cable end.

8. The housing according to claim 1, wherein the housing opening and the maintenance opening merge into one another when the maintenance opening is open.

9. The housing according to claim 1, wherein the maintenance cover encompasses one-half of the housing opening for the power cable end.

10. The housing according to claim 1, wherein the housing opening for the power cable is configured such that a power cable end, arranged in the housing opening in the closed position of the maintenance cover, is removable from the housing opening in the open position of the maintenance cover.

11. The housing according to claim 1, wherein the maintenance cover is designed to rest in a form-fit manner against a housing edge that forms the maintenance opening.

12. The housing according to claim 1, wherein the maintenance cover forms a wall section of the housing having an outer side which in the closed position of the maintenance cover is at least partially aligned with the outer side of the housing, and wherein the wall section has an inner side at which at least one protrusion section is formed, with which the maintenance cover in its closed position is supported on an inner side of the housing, on a protrusion section of the housing in the interior thereof, or on a structure that is situatable in the housing interior.

13. The housing according to claim 1, wherein the maintenance cover is completely separable from the housing.

14. The housing according to claim 1, wherein the maintenance cover and/or the housing are essentially formed from at least one injection-molded part.

15. An electric hand-held power tool comprising:
a housing according to claim 1;
a drive electronics system arranged in the housing interior to control a brushless drive that is arranged in the housing interior to drive a tool receptacle, which is arranged at a tool shaft that is coupled to the drive, and on which a tool is detachably mounted; and
a power cable that supplies power to the drive electronics system, and has a power cable end that extends through the housing opening into the interior subsection of the housing interior, and has lines that are connected to line contacts arranged in the interior subsection.

16. The housing according to claim 1, wherein the electric hand-held power tool is an angle grinder.
